(19) United States
(12) Patent Application Publication
(10) Pub. No.: US 2006/0143533 A1
(43) Pub. Date: Jun. 29, 2006

(54) Apparatus and system for testing of software

(75) Inventors: Daniel Dresser, San Jose, CA (US); Suja Viswesan, Santa Clara, CA (US)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: International Business Machines Corporation

(21) Appl. No.: 11/019,407

(22) Filed: Dec. 22, 2004

(51) Int. Cl. G06F 11/00

(52) U.S. Cl. 714/38

(57) ABSTRACT

There is provided a system and apparatus for testing software products. The apparatus includes a manager that (a) receives a request to run a test of a software product, and communicates with a resource to load the software product into the resource, and to automatically configure the software product for the test. There is also provided a system including the manager and a test automator. The test automator (a) receives the request to run the test from the manager, and (b) runs the test on the software. There is further provided a storage medium including instructions for controlling a processor to (a) receive a request to run a test of a software product, and (b) communicate with a resource to load the software product into the resource, and to automatically configure the software product for the test.

### BACKGROUND OF THE INVENTION

1. Field of the Invention

The present invention relates to a system and apparatus for running tests on software, and more particularly, to a system and apparatus for automatically configuring software based on test requests.

2. Description of the Related Art

Software development companies rely on two key factors to stay competitive: time to market and production cost. These factors grow in complexity when a product can run and/or interact with many other systems and various other programming languages. The combination for testing these scenarios is time consuming and costly to a company.

In today's technology industry, software developers and testers work together to increase a software product's quality. It is the tester's role to open defects in products and verify developers' defect fixes. Thorough testing of a product increases product quality, and detecting and fixing defects early in the development cycle costs the software maker significantly less than if the defect were found by the customer.

However, it is a daunting and costly task to effectively teach testers the various skill sets needed for the vast and growing number of programming languages and configuration setups to testers in order to fully test the product.

Present testing and verification solutions require human intervention. Developers rely on Quality Assurance testers to verify code integration in product builds. Numerous verification requests reduce testers' availability, and slows progress in writing new test cases and verifying defects. Productivity of new tests decreases with increased verification requests and results in more defects in the released product.

### SUMMARY OF THE INVENTION

There is a need for an automatic software testing system, such as a test regression suite, that allows a software developer or other user to run tests against a selected software product build.

There is also a need for an automatic software testing system that automatically configures software to be tested based on a request.

There is a further need for an automatic software testing system that minimizes the need for human interaction.

There is provided an apparatus that includes a manager that (a) receives a request to run a test of a software product, and communicates with a resource to load the software product into the resource, and to automatically configure the software product for the test.

There is also provided a system that includes a manager and a test automator. The manager (a) receives a request to run a test of a software product, and (b) communicates with a resource to load the software product into the resource and to automatically configure the software product for the test. The test automator (a) receives the request to run the test from the manager, and (b) runs the test on the software.

There is further provided a storage medium that includes instructions for controlling a processor to (a) receive a request to run a test of a software product, and (b) communicate with a resource to load the software product into the resource, and to automatically configure the software product for the test.

### BRIEF DESCRIPTION OF THE DRAWINGS

FIG. 1 is a drawing of a system for testing software.

FIG. 2 is a drawing of a testing system that includes numerous resources.

FIG. 3 is a drawing of a testing system that includes a client and a plurality of resources.

### DESCRIPTION OF THE INVENTION

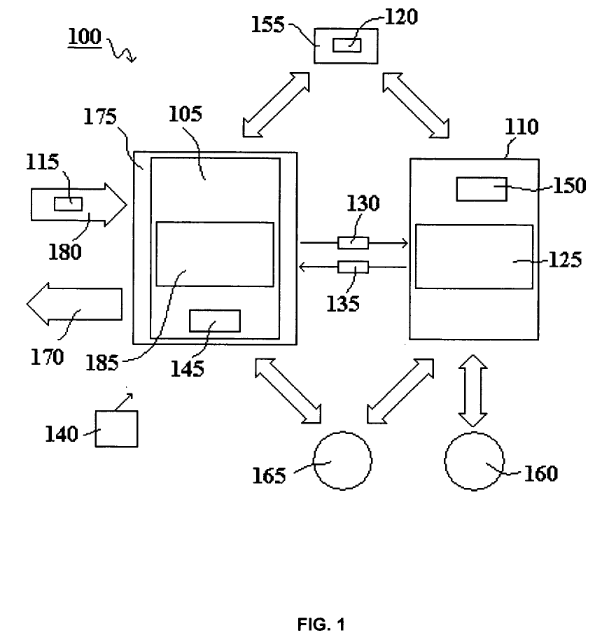

FIG. 1 is a drawing of a system 100 for testing software. System 100 includes a manager 105 and a resource 110. Resource 110 includes a memory 150 and a test automator 125. System 100 also includes a build storage medium 155, a test storage medium 160, and a data storage medium 165. Manager 105 is associated with an interface 175.

Manager 105 receives a request 115 to run a test of a software product 120, and communicates with resource 110 to load software product 120 into resource 110. Manager 105 also automatically configures software product 120 for the test.

Manager 105 configures software product 120 by, for example, turning certain options on or off or configuring functional options of software product 120. Other examples of configuring software product 120 include character set selection for selecting language options, turning debug tracing on or off, setting security options, and selecting communication features such as file transfer protocol (FTP), hyper text transfer protocol (HTTP) and simple mail transfer protocol (SMTP).

Request 115 may represent instructions from one or more users and one or more individual requests. Manager 105 can process multiple simultaneous requests, so that multiple users can initiate tests at the same time.

A test may require that one or more test modules, i.e. test cases, be run against software product 120. Manager 105, in response to request 115, determines which test cases are to be run against software product 120.

Manager 105 monitors a status of resource 110 and provides an output indicative of the status. The status of resource 110 may include, for example, whether or not resource 110 is available, a duration of a test being run on resource 110, identity of a user who initiated the test, and progress of the test.

Manager 105 also automatically configures resource 110 based on software product 120 and/or the test to be run. For example, manager 105 may restart or provide a process that is needed for the test, or install additional software needed for the test or for resource 110.

After the test is complete, manager 105 configures resource 110 with a default configuration. Manager 105 communicates with resource 110 to clean memory 150 to ensure a clean system and clean memory space for the next user of resource 110. Manager 105 also sends commands to resource 110 to reset product 120 back to default settings.

Resource 110 may be any hardware, e.g., a workstation or a server box, or software device upon which software product 120 is run. Software product 120 is loaded into memory 150 for testing, and may be configured to include an operating system such as Microsoft Windows™, Unix, AIX, or Linux.

Test automator 125 receives a request 130 from manager 105 to run the test, and thereafter runs the test against software product 120. Test automator 125 retrieves a test module or modules from test storage medium 160 and runs them against software product 120. Test automator 125 then calculates the success rate of the test, archives a result of the test, and provides a report 135 of the result of the test to manager 105. Although system 100 is shown as having test automator 125 installed in resource 110, test automator 125 may be remote from resource 110 and in communication with resource 110.

As used herein, a “software product” refers to a software program made from one or more software modules. Software product 120 may be configured as an independent software module or a plurality of software modules. Request 115 may request a test of a single software module, or a software product consisting of a plurality of software modules. The software module or modules may make up a new software product, or a new release or addition to an existing software product.

Manager 105 includes a processor 145 and an associated memory (not shown). The memory contains data and instructions for controlling processor 145 to perform the operations of manager 105 described herein. Although the instructions for controlling processor 145 are indicated as already being loaded into the memory, the instructions may be configured on a storage media 140 for subsequent loading into the memory. Storage media 140 can be any conventional storage media such as a magnetic tape, an optical storage media, a compact disk, or a floppy disk. Alternatively, storage media 140 can be a random access memory, or other type of electronic storage, located on a remote storage system.

Build storage medium 155 stores software product 120. In practice, build storage medium 155 may house one or more software products. Manager 105 loads software product 120 from build storage medium 155 into resource 110 from build storage medium 155.

Test storage medium 160 stores test modules that are run against software product 120.

Data storage medium 165 stores an outcome of the test and a status of resource 110. Resource 110 and/or test automator 125 sends information such as test results, test status, and resource status to data storage medium 165. Manager 105 can then retrieve the information and provide the information via output 170.

Interface 175 enables a user to provide an input 180 into, and receive output 170 from, manager 105. Interface 175 can be implemented, for example, as a web server. Interface 175 may be password protected, and may include a screen for presenting visual information, or a speaker or other device for audio communication, to provide output 170 to the user. Interface 175 may also include an input device, such as a keyboard, voice recognition, a mouse, or a touch screen. Input 180 includes, for example, selection of resource 110, selection of software product 120 to be tested, and selection of one or more tests to be run against software product 120. Output 170 is provided by manager 105. Output 170 includes, for example, an outcome of a test, a status of a test and a status of resource 110.

Manager 105 may optionally include a test automator 185. Test automator 185 communicates with test automator 125 to provide request 130 to test automator 125. Test automator 185 may be installed in manager 105, as shown in FIG. 1, or may be remote from manager 105 and in communication with manager 105.

The user can specify the types of tests to run on software product 120, or manager 105 can automatically determine the types of tests to run based on the user's request. In one example, test request 115 is a request for a regression test of software product 120, and manager 105 determines the type of test to run. In a case of software product 120 having more than one release, manager 105 determines the particular release against which the test will be run, and eliminates all groups of test cases, i.e. buckets, that cannot run against that particular release. Alternatively, manager 105 may run all buckets, and thus all test cases on software product 120. Manager 105 may run a test wherein the bucket or buckets to run against software product 120 are selected by the user. In another alternative, manager 105 runs individual test cases selected by the user.

Manager 105, in response to user input 180, builds the necessary test features into request 130 that is forwarded to resource 110. Request 130 includes instructions as to which test cases to run on software product 120. Test automator 125 runs the requested tests against software product 120.

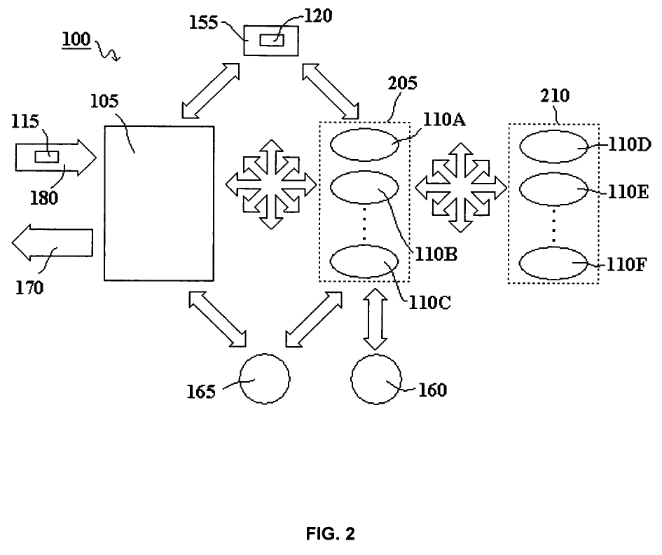

FIG. 2 is a drawing of an alternative embodiment of system 100 that includes a plurality of resources 110A, 110B, 110C, 110D, 110E and 110F. Resources 110A-110F are each similar to resource 110 as shown in FIG. 1, although resources 11A-110F need not include a test automator 125 as shown in FIG. 1. Manager 105 monitors a status of each of resources 110A-110F.

Each of resources 110A-110F is in communication with a test automator 125 (see FIG. 1) that receives a request to run the test from manager 105 and runs the test against software product 120. Alternatively, a single test automator 125 is in communication with, and runs tests on, more than one of resources 110A-110F.

Resources 110A-110F may be regression servers, upon which software product 120 is loaded for running regression tests against software product 120. Each of resources 110A-110F may be configured for various testing purposes, such as for various software product releases. Each configuration may be unique relative to one or more of the other resources. Each resource may have a default configuration or setting to which the resource is set when software module 120 is not loaded therein. Each resource is set to a default configuration by, for example, installing default options therein.

Resources 110A-110F may each be configured to a unique business or development problem domain. A business domain includes a specific customer configuration or special setup of software product 120. The business domain can be selected from various operating system platforms. A development domain may include a particular build release of software product 120, such as version 1.0, 1.4, 2.2, or the latest development build of software product 120.

In the embodiment of system 100 shown in FIG. 2, input 180 includes selection of one or more resources, selection of one or more software modules or software products to be tested, and selection of one or more tests to be run on a software product.

Output 170 indicates the status of one or more of resources 110A-110F, and also indicates an outcome and/or status of a test.

In using system 100, a user can check-out one of resources 110A-110F for testing by selecting a specific resource from resources 110A-110F. After testing is complete, the user then checks-in the selected resource by making the specific resource available for use by others or for different tests. The user can check-in and check-out resources 110A-110F using interface 175 (see FIG. 1). Alternatively, a user can specify a specific resource or type of resource upon which to run a test, and manager 105 can check-in or check-out resources automatically based on the user's request. Resources can be readily added and updated to resources 110A-110F as needed based upon development/testing needs and new configuration standards.

When a resource is checked-out, it is dynamically removed from resources 110A-110F such that no other users may check out the same resource. The user or manager 105 is then able to modify the resource's configuration settings if need be.

A maximum amount of time may be allotted for use of the checked-out resource. If the resource is not checked back into the system within the allotted amount of time, system 100 will run a set of diagnostic checks to return the resource back to its default configuration. Finally, the resource is checked back into resources 110A-110F.

Resources 110A-110C may reside as a pool 205 of resources that are used as clients. Resources 110D-110F may reside as a pool 210 of resources, where each of the resources in pool 210 can have software product 120 installed on them. Each resource in pool 205 can communicate with any resource in pool 210. Based on a request from manager 105, one resource in pool 205, for example resource 110A, contacts test storage medium 160 and extracts the latest stored tests to run against a resource in pool 210. Resource 110A also communicates with data storage medium 165 to store the results of the test. Alternatively, resources 110A-110F may all act as resources that can have software 120 installed therein for testing.

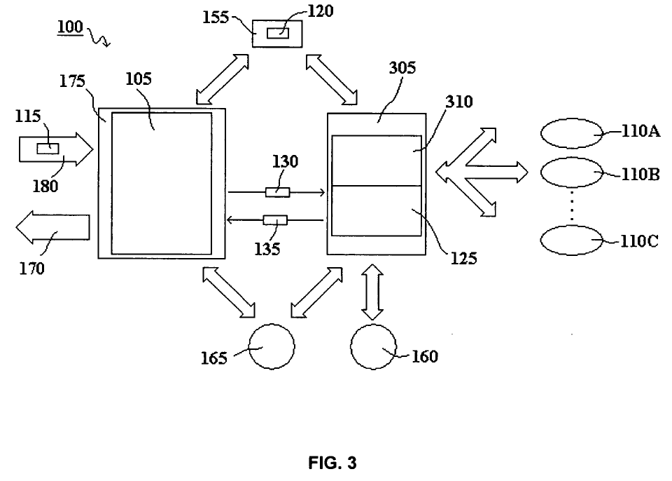

FIG. 3 is a drawing of another embodiment of system 100. System 100 includes manager 105, resources 110A-110C, and a client 305. Client 305 is a resource similar to resource 110A-110C, and includes test automator 125 and an optional test harness 310 to facilitate running the tests. System 100 also includes build storage medium 155, test storage medium 160, and data storage medium 165. Manager 105 is associated with an interface 175. Manager 105 communicates with client 305. Client 305 is in communication with resources 110A-110C. Test automator 125 receives test requests 130 from manager 105 and invokes test harness 310 to run test cases on selected resources. Test request 130 includes both the selection of the resource to be used and the test cases to be run against software product 120.

The following is an example of a use of system 100 for regression testing a software product, as directed by a user such as a software developer:

1. The user logs into system 100, via a web browser, i.e., interface 175, with a user id and password.

2. The user checks out a regression server, i.e. one of resources 110A-110C, upon which the user wants to run a test. For example, the user checks out resource 110A.

3. The user selects software product 120 to be tested.

4. The user may optionally select a test bucket or buckets to run. Alternatively, the user may enter a specific test case.

5. The user initiates the test through interface 175, such as by clicking a button to run the test.

6. Interface 175 transfers user-supplied test parameters in the form of request 115 to manager 105.

7. Manager 105 communicates the user-supplied test parameters in the form of request 130 to test automator 125, which is in communication with a selected resource 110A.

8. Test automator 125 extracts one or more test cases from test storage medium 160.

9. Test automator 125 invokes test harness 310 to run the extracted test cases.

10. Test harness 310 reports each test result to test automator 125, which provides report 135 to manager 105.

11. Manager 105 archives the test results in data storage medium 165 and sends a test result summary to the user via interface 175.

12. The user then checks-in resource 110A.

The following is an example of a use of system 100 in monitoring and managing the use of a resource:

1. The user logs into system 100 via interface 175.

2. The user accesses a Server Status page on interface 175 and clicks on a link to obtain information on a particular server, i.e., resource of resources 110A-110C.

3. Interface 175 displays information such as the resource platform, resource version, resource availability and any other related information.

4. The user either checks-out or checks-in a resource from resources 110A-110C. To check out a resource, the user selects an available resource and clicks on a “check out” button to check out a resource. To check in a resource, the user selects the resource that was checked out to the user and clicks on a “check in” button to check in the server and make the server available for other testing. Manager 105 then configures the resource to a default setting.

System 100 allows the user to select from a variety of tests written in numerous programming languages. Learning each programming language is time consuming and costly; therefore, these tests are written by those with the required language skill set. New tests can be created on a daily basis, and automatically added to the system. Thus, a test is available to system users immediately after a test is written, validated and stored in test storage medium 160.

A benefit of system 100 is that the user is abstracted from the implementation details of each test and only need know about the functionality being tested and the language that a test is written in. Thus, a developer or tester using system 100 does not need to know the programming language of the test, resource configurations, or how to install, configure, or execute the software product.

Also, a developer or tester does not need to know (a) anything about the hardware or operating system environments where the tests run, or (b) how to collect diagnostic data required to isolate test case failures. System 100 provides this information in a report for the user.

Development teams can share a pool of common resources, which can be configured in numerous settings. Such sharing helps lower the hardware cost by reducing the need for every combination of system configuration and testing to be setup for each developer.

System 100 can maintain a pool of resources, which may have a variety of configurations. New resources can easily be added or removed to this pool based upon development/testing needs and new configuration standards. The resources can be configured by those that have the knowledge and skill set in creating these various configurations. Thus, the user of the system only has to know about the “type” of resource to use rather than the underlying details of the configurations.

System 100 is a fully automated, “on demand”, systems that operate 24 hour a day, 7 days a week to a global wide community. Having system 100 operate at this level allows for more versatile testing, which helps reduce the number of development/testing cycles. A global workforce can interact with system 100 and share the same resources. Hence, a developer does not have to coordinate with a quality assurance tester to run test cases. This allows for a more flexible work schedule in that a developer can verify the developer's work and integrate the developer's work without the need for the quality assurance tester to test it for them. System 100 thus provides a way to optimize both people resources and hardware resources so that the cost of testing software can be reduced substantially.

It should be understood that various alternatives, combinations and modifications of the teachings described herein could be devised by those skilled in the art. The present invention is intended to embrace all such alternatives, modifications and variances that fall within the scope of the appended claims.

What is claimed is:

1. An apparatus, comprising:
a manager that (a) receives a request to run a test of a software product, and (b) communicates with a resource to load said software product into said resource, and to automatically configure said software product for said test.

2. The apparatus of claim 1, further comprising a test automator that (a) receives said request to run said test from said manager, and (b) runs said test on said software.

3. The apparatus of claim 2, wherein said test automator reports an outcome of said test to said manager.

4. The apparatus of claim 1, wherein said manager monitors a status of said resource and provides an output indicative of said status.

5. The apparatus of claim 1,
wherein said manager automatically configures said resource based on an item selected from the group consisting of said software product, said test, and a combination thereof, and
wherein said manager configures said resource with a default configuration after said test is complete.

6. The apparatus of claim 1, further comprising an interface through which a user may select said resource, select said test, and receive an outcome of said test.

7. The apparatus of claim 1,
wherein said resource is a member of a plurality of resources, and
wherein said manager monitors a status of each of said plurality of resources and provides an output indicative of said status of said plurality of resources.

8. The apparatus of claim 7, wherein each of said plurality of resources is in communication with a test automator that (a) receives said request to run said test from said manager, and (b) runs said test on said software.

9. A system, comprising:
a manager that (a) receives a request to run a test of a software product, and (b) communicates with a resource to load said software product into said resource, and to automatically configure said software product for said test; and
a test automator that (a) receives said request to run said test from said manager, and (b) runs said test on said software.

10. The system of claim 9, wherein said automator reports an outcome of said test to said manager.

11. The system of claim 9, wherein said manager monitors a status of said resource and provides an output indicative of said status.

12. The system of claim 9,
wherein said manager automatically configures said resource based on an item selected from the group consisting of said software product, said test, and a combination thereof, and
wherein said manager configures said resource with a default configuration after said test is complete.

13. The system of claim 9, further comprising a test storage medium for storing test modules, wherein said test automator retrieves said test modules from said test storage medium based on said request.

14. The system of claim 9, further comprising a build storage medium for storing said software product, wherein said manager loads said software product into said resource from said build storage medium.

15. The system of claim 9, further comprising a data storage medium for storing an outcome of said test and a status of said resource.

16. The system of claim 9, further comprising an interface through which a user may select said resource, select said software, select a test, and receive an outcome of said test.

17. The system of claim 9,
wherein said resource is a member of a plurality of resources, and
wherein said manager monitors a status of each of said plurality of resources and provides an output indicative of said status of said plurality of resources.

18. The system of claim 17, wherein each of said plurality of resources is in communication with a test automator that (a) receives said request to run said test from said manager, and (b) runs said test on said software.

19. A storage medium, comprising instructions for controlling a processor to (a) receive a request to run a test of a software product, and (b) communicate with a resource to load said software product into said resource, and to automatically configure said software product for said test.

20. The storage medium of claim 19, further comprising instructions for (a) automatically configuring said resource based on an item selected from the group consisting of said software product, said test, and a combination thereof, and (b) configuring said resource with a default configuration after said test is complete.
